(19) United States
(12) Patent Application Publication
(10) Pub. No.: US 2008/0114905 A1
(43) Pub. Date: May 15, 2008

(54) Digital Video Recorder, Device for Executing a Task, and Method Thereof

(75) Inventor: Shih-Hao Chen, Hsin-Chu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 11/558,607

(22) Filed: Nov. 10, 2006

(51) Int. Cl. G06F 13/10

(52) U.S. Cl. 710/16

(57) ABSTRACT

A digital video recorder, a device for executing a task, and a method thereof are provided. The digital video recorder for executing the task comprises a receiver, a detector, a determination unit, a memory, and a display. The receiver receives a command and the detector detects the capability of the digital video recorder. The determination unit determines whether the digital video recorder can execute the task according to the capability at a first time. If not, the determination unit determines whether the digital video recorder can execute the task at a second time, or whether another digital video recorder can execute the task at a third time. In addition, the memory can store a task result, which can be shown on the display.

### CROSS-REFERENCES TO RELATED APPLICATIONS

Not applicable

### BACKGROUND OF THE INVENTION

1. Field of the Invention

The present invention relates to a digital video recorder, a device for executing a task, and a method thereof; in particular, it relates to a digital video recorder, a multimedia storage apparatus, and a method for executing a recording process.

2. Descriptions of the Related Art

Recording devices which are scheduled to record TV programs, web pages or videos for later viewing are commonly used. However, inputting schedule information into a recording device is limited to time and place. For example, the user may need to write down the broadcasting information or record the broadcasting information into a memory of a mobile device when obtaining the broadcasting information from the Internet through the mobile device. Then, the user has to input the broadcasting information into a recording device to preset a recording time so that the program is recorded when he/she is away from his/her TV. Inputting the broadcasting information into the recording device can not only be inconvenient, but is also prone to mistakes. Moreover, the user wastes time when he/she repeatedly inputs the broadcasting information, turning the recording process into a complicated hassle.

U.S. Patent Publication No. 2004/0197082 discloses a broadcasting program reservation-recording system 1 as shown in FIG. 1. The broadcasting program reservation-recording system 1 includes a PDA comprising an antenna 11, a CDMA module 13, a storage unit 15, a controller 17, and a display unit 19. The controller 17 comprises a remote control module 171. The CDMA module 13 receives broadcasting program information via the antenna 11. The remote control module 171 exchanges data with an external device or controls the external device via a wireless communication. Furthermore, broadcasting program information and control data for each external device are stored in the storage unit 15. The controller 17 can convert the broadcasting program information stored in the storage unit 15 into data information which is suitable for display. Consequently, the display unit 19 can display the data information onto a screen corresponding to the broadcasting program information output from the controller 17.

However, the conventional broadcasting program reservation-recording system 1 is only applicable to a PDA and not suitable for other digital recording devices. Furthermore, this broadcasting program reservation-recording system 1 can be applied for only one recording device. When the PDA runs out of electric power while recording data, it can not resume the recording of data if transferred to another recording device. Moreover, if the PDA is requested to record two data with a time conflict, the user has to choose only one for recording.

Therefore, a solution that can (1) be applicable to different recording devices, (2) simplify the recording process and (3) allocate the recording process to another recording device according to the capability thereof, is urgently required in this field.

### SUMMARY OF THE INVENTION

The primary objective of this invention is to provide a first device in a system, which comprises a plurality of devices to execute a task. The first device comprises a receiver, a detector, and a determination unit. First, the receiver receives a command. Then, the detector detects a capability of the first device. Soon after, the determination unit determines whether the first device is capable of executing the task at a first time. If not, the determination unit determines whether the first device can execute the task at a second time, or whether a second device of the plurality of devices can execute the task at a third time.

Another objective of this invention is to provide a method for executing a recording process. The method comprises the following steps: receiving a command by a first device; detecting a capability of the first device; determining whether the first device can execute the task according to its capability at a first time; and if not, determining whether the first device can execute the task at a second time, or whether a second device of the plurality of devices can execute the task at a third time.

Still another objective of this invention is to provide a digital video recorder. The digital video recorder comprises a receiver, a detector, a determination unit, a memory, and a display. First, the receiver receives a command, and then, the detector detects a capability of the digital video recorder. The determination unit subsequently determines whether the digital video recorder can execute the task according to its capability at a first time. If not, the determination unit determines whether the digital video recorder can execute the task at second time, or whether another digital video recorder can execute the task at a third time. In addition, the task results can be stored and displayed.

Yet, a further objective of this invention is to provide a first device in a system which comprises a plurality of devices to execute a task. The first device comprises: means for receiving a command; means for detecting a capability of the first device; means for determining whether the first device can execute the task according to its capability at a first time; and if not, determining whether the first device can execute the task at a second time, or whether a second device of the plurality of devices can execute the task at a third time.

The digital video recorder, the device, and the method of the present invention can simplify the recording process and execute the recording process according to the capabilities of the devices. Certainly, it is more convenient for a user to record data thereby.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a conventional broadcasting program reservation-recording system;

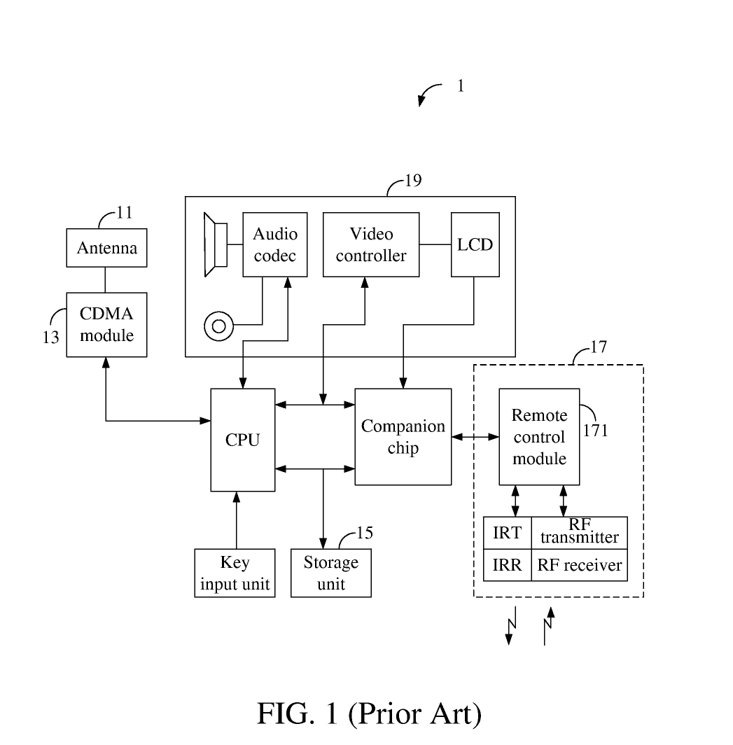

FIG. 2 shows the first embodiment of the present invention;

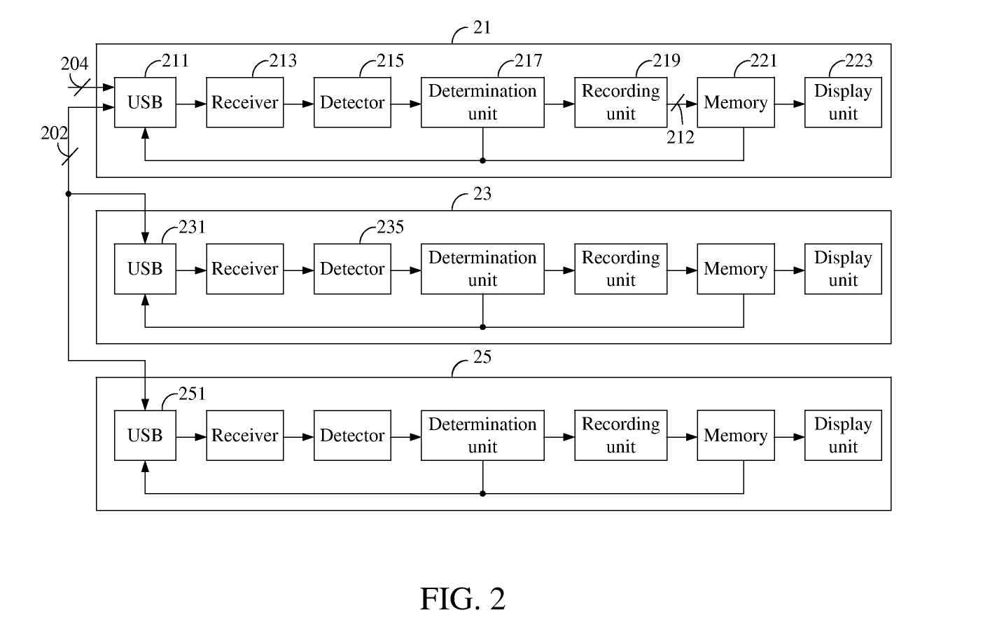

FIG. 3 shows a flow chart of the second embodiment of the present invention; and

FIG. 4 shows another flow chart of the second embodiment of the present invention.

### DESCRIPTION OF THE PREFERRED EMBODIMENT

In this specification, the term “according to” is defined as “replying to” or “reacting to.” For example, “according to a signal” means “replying to a signal” or “reacting to a signal” without necessity of direct signal reception.

The first embodiment of the present invention discloses a first device in a system, which comprises a plurality of devices, to execute a task. In this embodiment, the task can be a recording process. More particularly, the task can be the recording process of a TV program, a program schedule, a web page, or a video retrieved from the Internet, which is recorded into a storage device. The device can either be a DVR (digital video recorder), a PMP (portable medium player), a PDA (personal digital assistant), a microcenter, a mobile device, or any other device which can execute the recording process. Respectively, the first device can be a first digital video recorder 21 set in the living room, a second device of the plurality of devices can be a second digital video recorder 23 set in the study, and a third device of the plurality of devices can be a third digital video recorder 25 set in the dining room. The aforesaid devices can communicate with each other through interfaces, wherein the interface is associated with a memory card, a wireless transmission, or a wire transmission. The aforesaid wire transmission includes wired Internet communication and data transmission with a line, for example, USB transmission.

Each of the plurality of devices comprises a receiver, a detector, a determination unit, an interface, a recording unit, a memory, and a display unit. When a user wants to record a program broadcasted at 6:00 PM, he/she would provide a manual input 204 or select the program from an EPG (electronic program guide) to request the first digital video recorder 21 to execute the recording process. Then, the receiver 213 of the first digital video recorder 21 receives the command, which is either generated according to the manual input 204 inputted by the user, the EPG, or data transmitted from the third digital video recorder 25 through the interface.

In the first embodiment, the interfaces of the three digital video recorders 21, 23, 25 can utilize the wire transmission. For example, USBs 211, 231, 251 associated with a USB data transmission line 202 can be adopted. The user can still command the first digital video recorder 21 to execute the task. Then, the detector 215 of the first digital video recorder 21 detects the capability of the first digital video recorder 21. Specifically, the capability can be determined according to a storage status, power status, task scheduling status, or timer recording status. The storage status assesses the remaining memory capacity of the memory 221 of the first digital video recorder 21 for determining whether the memory capacity is capable of storing a task result. The power status relates to the status of power consumption or the surplus power of the first digital video recorder 21. The task scheduling status checks the status of the task list of the first digital video recorder 21 to determine if there are overlapping tasks. The timer recording status relates to the recording schedule of the first digital video recorder 21.

The determination unit 217 of the first digital video recorder 21 determines whether the first digital video recorder 21 can execute the task at a first time, i.e. a first requested time, according to its capability, for example, at 6:00 PM. If yes, the recording unit 219 of the first digital video recorder 21 would perform the recording at 6:00 PM, and then store a recording result 212 in the memory 221. Once the user wants to watch the recording result 212, the recording result 212 will be shown on the display unit 223 of the first digital video recorder 21. If the first digital video recorder 21 is unable to execute the task due to, for example, insufficient memory capacity, power shortage, tasks overlaps, or a full task schedule, the determination unit 217 would determine whether the first digital video recorder 21 can execute the task at a second time, i.e. a second requested time, or whether the second digital video recorder 23 can execute the task at a third time.

In this embodiment, the aforesaid second time would be a first rerun time of the program, for example, at 10:00 PM. Furthermore, the third time can be a second rerun time or be the same as the first or second time. In this embodiment, the third time is identical with the first time, 6:00 PM. With respect to the determination unit 217, it is unnecessary to determine the priorities between the above-mentioned two determinations. One of the determinations would be previously selected according to the capability of the first digital video recorder 21 and the capability of the second digital video recorder 23, wherein the capability of the second digital video recorder 23 is detected by the detector 235 of the second digital video recorder 23. In this embodiment, the determination unit 217 may determine whether the first digital video recorder 21 can first execute the task at 10:00 PM. If the first digital video recorder 21 cannot execute the task at 10:00 PM, then the determination unit 217 would determine whether the second digital video recorder 23 can execute the task at 6:00 PM according to the capability of the second digital video recorder 23. Furthermore, the determination unit 217 would determine according to the capability of the second digital video recorder 23. This capability is transmitted through the USB data transmission line 202 to the first digital video recorder 21. If the determination unit 217 determines that the second digital video recorder 23 can execute the task at 6:00 PM, the first digital video recorder 21 would transmit the command to the second digital video recorder 23 through the USB data transmission line 202. Finally, the second digital video recorder 23 would execute the task at 6:00 PM thereby.

When the determination unit 217 determines that any device can execute the task, the determination unit 217 further determines whether any of the other devices is capable of storing the task result according to the storage status of the memories, the power status, etc. The task result may comprise a TV program, a program schedule, a web page, or a video retrieved from Internet. Moreover, the determination unit 217 further determines whether any device is capable of displaying the task result on the display units according to the capabilities of the devices or according to an instruction inputted by the user.

Rather than using digital video recorders as the first device and the second device, people skilled in the art may modify the present invention so that a mobile device, for example, a cell phone, can be the first device while a digital video recorder can be a second device. For instance, the user can browse a web page on the mobile device, and try to store a video file which is attached thereon. Limited to the power and storage status of the mobile device, the user has to download the information using the digital video recorder at home. In this case, the user saves the web page, and transmits the web page to the digital video recorder through an interface, for example, the memory card, for requesting the digital video recorder to record the video. As compared with the prior art, the user does not have to search the web page again by using the digital video recorder afterwards. Thus, the present invention discloses a simpler way to perform the recording process.

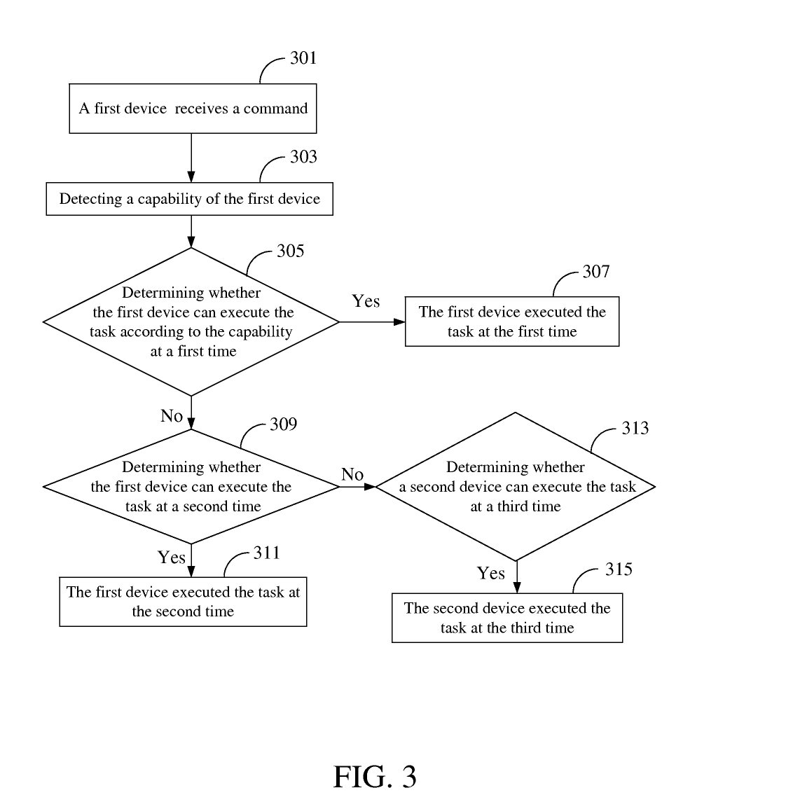

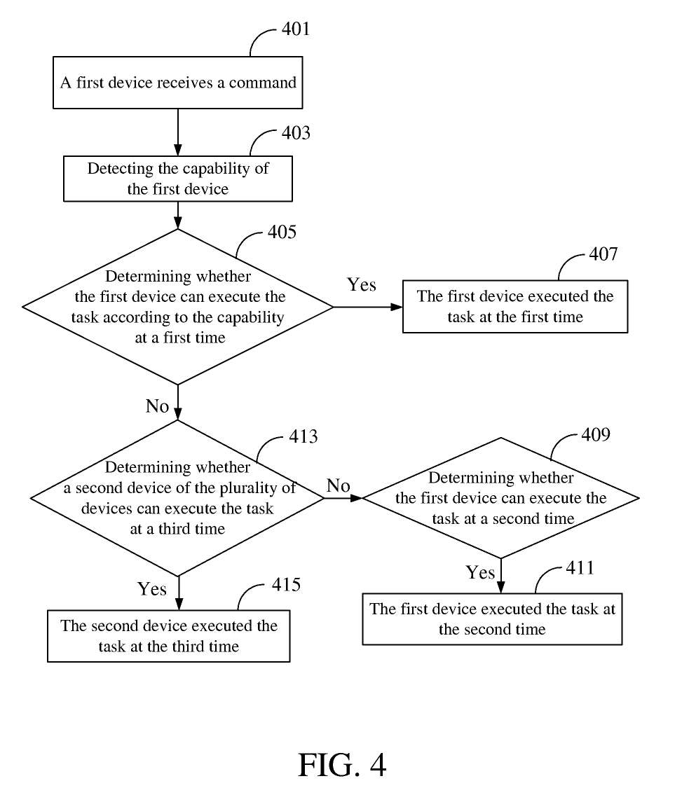

The second embodiment of the present invention is a method for the system, which comprises a plurality of devices to execute a task, as noted in the first embodiment. FIG. 3 shows a flow chart illustrating this method. In step 301, a first device of the plurality of devices receives a command. In step 303, a capability of the first device is detected. Step 305 determines whether the first device can execute the task at a first time according to its capability. If yes, the first device executes the task at the first time in step 307. If not, the determination unit 17 further determines whether the first device can execute the task at a second time in step 309. If yes, the first device executes the task at the second time in step 311, and if not, the determination unit 17 determines whether a second device of the plurality of devices can execute the task at a third time in step 313. If “yes” is determined in step 313, the second device executes the task at the third time as shown in step 315. The aforementioned steps are not limited. For example, as shown in FIG. 4, step 401 to step 407 is similar to steps 301 to 307. If “no” is determined in step 405, step 413 will be executed. If “yes” is determined in step 413, step 415 is then executed. If “no” is determined in step 413, step 409 would be executed and if “yes” is further determined in step 409, the method of this embodiment will go to step 411.

In addition to the steps shown in FIG. 3 and FIG. 4, the second embodiment is able to execute all of the operations or functions recited in the first embodiment. Those skilled in the art can straightforwardly realize how the second embodiment performs these operations and functions based on the above descriptions of the first embodiment. Therefore, the descriptions for these operations and functions are redundant and not repeated herein.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A first device in a system comprising a plurality of devices to execute a task, comprising:
a receiver for receiving a command;
a detector for detecting a capability of the first device; and
a determination unit for determining whether the first device can execute the task according to the capability at a first time, if no, for determining whether the first device can execute the task at a second time or whether a second device of the plurality of devices can execute the task at a third time.

2. The first device as claimed in claim 1, wherein the task is a recording process.

3. The first device as claimed in claim 1, wherein each of the plurality of devices is one of a DVR, a PMP, a PDA, a microcenter, and a mobile device.

4. The first device as claimed in claim 1, wherein the detector further detects a capability of the second device.

5. The first device as claimed in claim 1, further comprising an interface, wherein if the determination unit determines the second device can execute the task, the first device transmits the command to the second device through an interface, and the interface is associated with one of a memory card, a wireless transmission, and a wire transmission.

6. The first device as claimed in claim 1, wherein the command is generated according to a manual input.

7. The first device as claimed in claim 1, wherein the command is generated according to an EPG.

8. The first device as claimed in claim 1, wherein the command is transmitted from a third device of the plurality of devices.

9. The first device as claimed in claim 1, wherein the capability is determined according to a storage status.

10. The first device as claimed in claim 1, wherein the capability is determined according to a power status.

11. The first device as claimed in claim 1, wherein the capability is determined according to a task scheduling status.

12. The first device as claimed in claim 1, wherein the capability is determined according to a timer recording status.

13. The first device as claimed in claim 1, wherein the determination unit further determines whether any of the plurality of devices has a capability to store a task result.

14. The first device as claimed in claim 1, wherein the determination unit further determines whether any of the plurality of devices is able to display a task result.

15. A method for a system comprising a plurality of devices to execute a task, comprising:
receiving a command by a first device of the plurality of devices;
detecting a capability of the first device;
determining whether the first device can execute the task according to the capability at a first time; and
if no, determining whether the first device can execute the task at a second time or whether a second device of the plurality of devices can execute the task at a third time.

16. The method as claimed in claim 15, wherein the task is a recording process.

17. The method as claimed in claim 15, wherein each of the plurality of devices is one of a DVR, a PMP, a PDA, a microcenter, and a mobile device.

18. The method as claimed in claim 15, further comprising a step of detecting a capability of the second device.

19. The method as claimed in claim 15, further comprising a step of transmitting the command to the second device if the second device is determined to be able to execute the task, wherein the transmission is executed through one of a memory card, a wireless transmission, and a wire transmission.

20. The method as claimed in claim 15, wherein the command is generated according to a manual input.

21. The method as claimed in claim 15, wherein the command is generated according to an EPG.

22. The method as claimed in claim 15, wherein the command is transmitted from a third device of the plurality of devices.

23. The method as claimed in claim 15, wherein the capability is determined according to a storage status.

24. The method as claimed in claim 15, wherein the capability is determined according to a power status.

25. The method as claimed in claim 15, wherein the capability is determined according to a task scheduling status.

26. The method as claimed in claim 15, wherein the capability is determined according to a timer recording status.

27. The method as claimed in claim 15, further comprising a step of determining whether any of the plurality of devices has a capability to store a task result.

28. The method as claimed in claim 15, further comprising a step of determining whether any of the plurality of devices is able to display a task result.

29. A digital video recorder, comprising:
a receiver for receiving a command;
a detector for detecting a capability of the digital video recorder;
a determination unit for determining whether the digital video recorder can execute the task according to the capability at a first time, if no, for determining whether the digital video recorder can execute the task at a second time or whether another digital video recorder can execute the task at a third time;
a memory for storing a task result of the task; and
a display for displaying a task result of the task.

30. A first device in a system comprising a plurality of devices to execute a task, comprising:
means for receiving a command;
means for detecting a capability of the first device;
means for determining whether the first device can execute the task according to the capability at a first time, if no, for determining whether the first device can execute the task at a second time or whether a second device of the plurality of devices can execute the task at a third time.
